(19) United States
(12) Patent Application Publication
(10) Pub. No.: US 2017/0089373 A1
(43) Pub. Date: Mar. 30, 2017

(54) DOWEL BAR SPRING CLIP

(71) Applicant: Composite Rebar Technologies, Inc., Madison, WI (US)

(72) Inventor: Richard A. Schulte, Madison, WI (US)

(73) Assignee: Composite Rebar Technologies, Inc., Madison, WI (US)

(21) Appl. No.: 15/276,615

(22) Filed: Sep. 26, 2016

Related U.S. Application Data
(60) Provisional application No. 62/233,256, filed on Sep. 25, 2015.
(60) Provisional application No. 62/233,264, filed on Sep. 25, 2015.

(51) Int. Cl. F16B 7/04; F16B 2/24; E01C 11/14

(52) U.S. Cl. CPC F16B 7/0493; E01C 11/14; F16B 2/248

(57) ABSTRACT

A dowel bar spring clip may include a central torsion spring portion having leg extensions. The leg extensions may be configured to releasably engage a dowel bar basket. The torsion spring portion may be configured to securely encompass a dowel bar, such that the dowel bar is secured to the dowel bar basket by the clip. The dowel bar spring clip may be removable, for example to replace or reposition the dowel bar relative to the basket.

### CROSS-REFERENCES

This application claims the benefit under 35 U.S.C. §119(e) of the priority of U.S. Provisional Patent Application Ser. No. 62/233,256, filed Sep. 25, 2015, and U.S. Provisional Patent Application Ser. No. 62/233,264, filed Sep. 25, 2015, the entireties of which are hereby incorporated by reference for all purposes.

The following related applications and materials are incorporated herein, in their entireties, for all purposes: U.S. Pat. No. 8,591,139.

### FIELD

This disclosure relates to systems and methods relating to highway construction and concrete work. More specifically, the disclosed embodiments relate to systems and methods for connecting dowel bars to corresponding support structures.

### INTRODUCTION

Dowel bars are typically used in road and highway construction, to transfer load from one concrete slab to the next. Dowel alignment must be perpendicular to the concrete joint. Typically, only one end portion of each dowel is securely attached to an underlying dowel basket. This enables concrete to slide over the dowels as it expands and contracts.

A dowel basket generally includes a wire truss structure that holds dowel bars in mutual alignment with respect to height, horizontal/vertical angle, and spacing during the concrete construction process. Standard industry practice is to weld the dowels to the basket, leaving one end of each dowel bar free to move longitudinally with respect to the basket assembly. However, welding may be undesirable or impractical, depending on dowel bar materials. Various clips have been used to overcome this issue with welding. However, known clip solutions may be difficult to install or remove, may require special tools, and/or may fail to secure the dowel bar adequately.

### SUMMARY

The dowel bar spring clips described herein include a central torsion spring configured to encompass the full circumference of the dowel bar, and have engagement members that may be easily manipulated to engage both the dowel bar and the basket.

The present disclosure provides systems, apparatuses, and methods relating to dowel bar spring clips for dowel bar assemblies, such as those used in road construction. In some embodiments, a device for attaching a dowel bar to a dowel basket may include: a torsion spring portion configured to fit securely around a complete circumference of a dowel bar; and an engagement member extending from the torsion spring, the engagement member having a distal end portion configured to releasably engage the dowel basket.

In some embodiments, a load transfer assembly for road construction may include: a dowel basket; a dowel bar coupled to the dowel basket; and a spring clip including a torsion spring having a plurality of coils fitting securely around a complete circumference of an end portion of the dowel bar, the torsion spring having a pair of leg extensions removably hooked onto the dowel basket, such that the spring clip releasably secures the end portion of the dowel bar to the dowel basket.

In some embodiments, a method for securing a dowel bar to a dowel bar basket may include: installing a dowel bar on a dowel bar basket; expanding a torsion spring portion of a spring clip by applying a squeezing force on opposing extension members of the clip, thereby increasing an effective diameter of the torsion spring; placing the torsion spring portion over an end of the dowel bar, such that the dowel bar and the torsion spring are coaxial and the torsion spring surrounds the outer circumference of the dowel bar; placing hook ends of the extension members of the clip adjacent to hookable portions of the dowel bar basket; and contracting the torsion spring to cause the spring clip to engage the dowel bar by releasing the squeezing force on the extension members.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a perspective view of an illustrative dowel basket assembly showing dowel bars installed on a first type of dowel basket.

FIG. 2 is an isometric view of another illustrative dowel basket assembly, showing dowel bars installed on a second type of dowel basket.

FIG. 3 is an isometric view of an illustrative dowel bar and portion of a basket, with the dowel bar secured to the basket by an illustrative spring clip in accordance with aspects of the present disclosure.

FIG. 4 is a bottom view of the dowel bar, basket, and spring clip of FIG. 3.

FIG. 5 is an end elevation view of the dowel bar, basket, and spring clip of FIG. 3.

FIG. 6 is a partial side elevation view of the dowel bar, basket, and spring clip of FIG. 3, showing the dowel bar in phantom lines.

FIG. 7 is an isometric view of an illustrative dowel bar spring clip according to the present teachings.

FIG. 8 is a top view of the dowel bar spring clip of FIG. 7.

FIG. 9 is a bottom view of the dowel bar spring clip of FIG. 7.

FIG. 10 is an end view of the dowel bar spring clip of FIG. 7, as viewed from an inboard vantage point.

FIG. 11 is an end view of the dowel bar spring clip of FIG. 7, as viewed from an outboard vantage point.

FIG. 12 is an isometric view of a dowel bar and basket, showing an illustrative alternative spring clip.

FIG. 13 is an isometric view of a dowel bar and basket, showing another illustrative alternative spring clip.

FIG. 14 is an isometric view of a dowel bar and basket, showing another illustrative alternative spring clip.

FIG. 15 is an isometric view of a dowel bar and basket, showing yet another illustrative alternative spring clip.

FIG. 16 is a flow chart showing steps in an illustrative method for attaching a dowel bar to a dowel bar basket using a spring clip in accordance with aspects of the present disclosure.

### DESCRIPTION

Various embodiments of a spring clip for dowel bars, as well as related methods, are described below and illustrated in the associated drawings. Unless otherwise specified, a dowel bar spring clip and/or its various components may, but are not required to, contain at least one of the structure, components, functionality, and/or variations described, illustrated, and/or incorporated herein. Furthermore, the process steps, structures, components, functionalities, and/or variations described, illustrated, and/or incorporated herein in connection with the present teachings may, but are not required to, be included in other similar dowel bar attachment mechanisms. The following description of various embodiments is merely exemplary in nature and is in no way intended to limit the disclosure, its application, or uses. Additionally, the advantages provided by the embodiments, as described below, are illustrative in nature and not all embodiments provide the same advantages or the same degree of advantages.

### DEFINITIONS

The following definitions apply herein, unless otherwise indicated.

“Substantially” means to be essentially conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

The terms “inboard,” “outboard,” “top,” “bottom,” and the like are intended to be understood in the context of a host dowel basket on which dowel bars may be horizontally mounted or otherwise attached using spring clips described herein, where “outboard” generally correlates to the opposing ends of the dowel bars. For example, “outboard” may indicate a relative position that is farther from the centerline of the basket, in the direction parallel to the long axes of the dowel bars, or a direction that is away from the basket centerline. Conversely, “inboard” may indicate a direction toward the centerline, or a relative position that is closer to the centerline. In the absence of a host basket, the same directional terms may be used as if the basket were present. For example, even when viewed in isolation, a spring clip may have an “inboard” side, based on the fact that the side in question would be installed facing the centerline of a host basket.

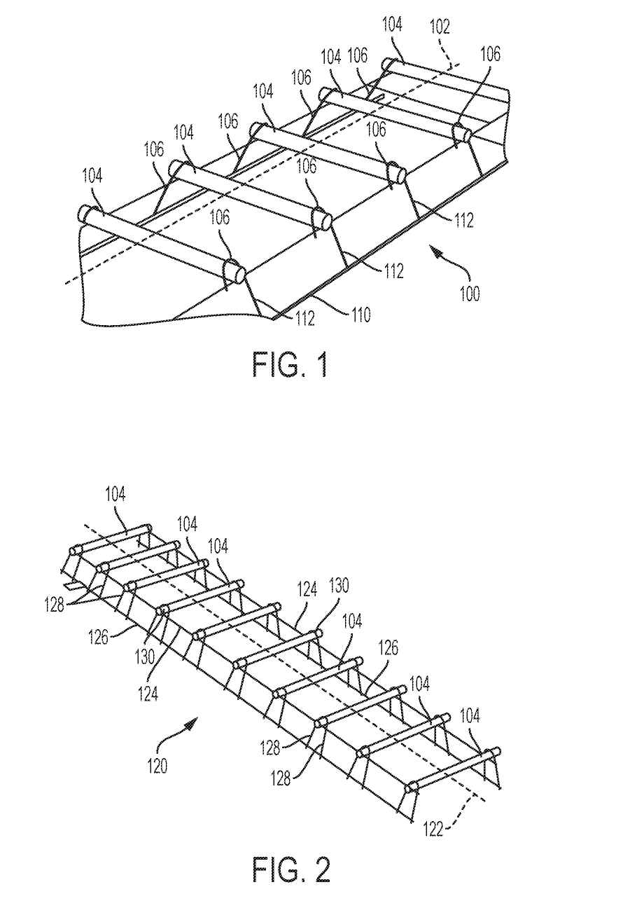

“Dowel bar” refers to one of the elongate, cylindrical, high shear strength rods typically used in concrete highway construction. Dowel bars are typically formed of conventional, structural steel (non-stainless), although other materials or combinations of materials may be used. Dowel bars are employed in multiple numbers, typically at 1-foot lateral-spacing intervals, as shear-bridging, slab-to-slab load-transfer structures at each joint between adjacent highway slabs. Highway slabs are usually formed of poured concrete (e.g., high performance concrete). Dowel bars typically function to furnish appropriate load-transfer shear strength between adjacent slabs while at the same time (a) accommodating slab expansion and contraction due to ambient thermal changes, and (b) minimizing the phenomenon known as slab faulting at the joints between adjacent slabs. Dowel bars may comprise materials or combinations of materials, such as epoxy-coated structural steel, zinc-coated structural steel, solely stainless steel, stainless-steel-jacketed conventional structural steel, and purely single-unit plastic composite materials. Dowel bars may also comprise fiber-reinforced polymer (FRP) materials. In some examples, dowel bars may include a steel bar partially or completely enclosed by FRP materials. Dowel bars typically have a circular cross section. However, other cross-sectional shapes may be used, such as a polygonal cross section (e.g., hexagonal). In some examples, dowel bars may be hollow, such as a hollow tube having one or more layers. In some examples, dowel bars may include a portion that is hollow, such as a hollow steel tube completely enclosed within an FRP jacket or sleeve. Dowel bars may have a smooth exterior, or may have a textured or irregular exterior surface, or any combination of these. Suitable dowel bars are described, for example, in U.S. Pat. No. 8,591,139. Examples of dowel bars are shown in FIGS. 1-2 and throughout the drawings. Dowel bars may be interchangeably referred to as dowels, dowel rods, and/or bars.

The terms “basket,” “dowel basket,” and “basket assembly” generally refer to a structure that holds multiple dowel bars in mutual alignment with respect to height, horizontal/vertical angle, and spacing during the concrete construction process. Basket assemblies may comprise any suitable components and structures, such as a truss or frame, configured to hold the dowel bars at the desired spacing, height, and orientation, while also permitting some longitudinal movement of the individual dowel bars. Basket assemblies may be constructed of steel wire or the like. Examples of baskets are shown in FIGS. 1-2. For example, a basket 100 is shown in FIG. 1, having a centerline 102. A plurality of dowel bars 104 are mounted in basket 100, and held in their general orientations and positions by hoop structures 106 formed in the basket. In this example, basket 100 has an upper horizontal cross-member 108 and a lower horizontal cross-member 110. Hoop structures 106 are formed at an upper end of each of several single upright members 112. In another example, FIG. 2 shows a basket 120 having a centerline 122, an upper cross-member 124, a lower cross-member 126, and a plurality of A-frame upright members 128 forming hoop structures 130 to hold a plurality of dowel bars 132.

Overview

In general, a dowel bar spring clip according to the present teachings may include a dowel-securing torsion member and a basket engagement member. The torsion member may include any suitable structure or mechanism configured to securely and releasably grip a dowel bar. For example, the torsion member may include a torsion spring configured to encompass an outer circumference of the dowel bar. Such a spring torsion member may securely grip dowel bar by virtue of having a resting diameter slightly less than the diameter of the dowel bar. Continuing with this example, the torsion spring may further be releasable from the dowel bar by imparting an expanding torque on the spring, thereby increasing the effective diameter of the spring and allowing the torsion member to slide on or off the dowel.

The basket engagement member may include any suitable structure or device configured to connect the clip to a portion of a basket assembly. For example, the basket engagement member may include one or more hooks, pins, arms, legs, and/or other structures. The torsion member and the basket engagement member may be operatively connected, directly or indirectly. For example, in the example above, the basket engagement member may include extensions of the two ends of the torsion spring. These extensions may be configured to extend to and engage with the basket assembly. In embodiments where the basket engagement member is an extension of or is integrated with the torsion member, both portions of the clip may be manipulated at the same time. For example, placing torque on the torsion member may involve manipulation of the basket engagement member, which in turn may place the basket engagement member in position to simultaneously or subsequently engage with the basket assembly.

### EXAMPLES, COMPONENTS, AND ALTERNATIVES

The following sections describe selected aspects of exemplary dowel bar spring clips, as well as related systems and/or methods. The examples in these sections are intended for illustration and should not be interpreted as limiting the entire scope of the present disclosure. Each section may include one or more distinct embodiments or examples, and/or contextual or related information, function, and/or structure.

Illustrative Spring Clip

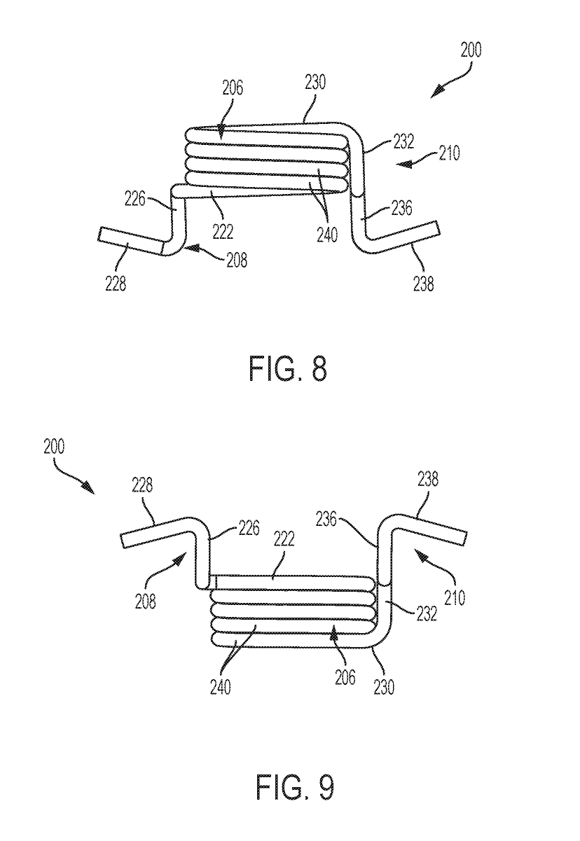

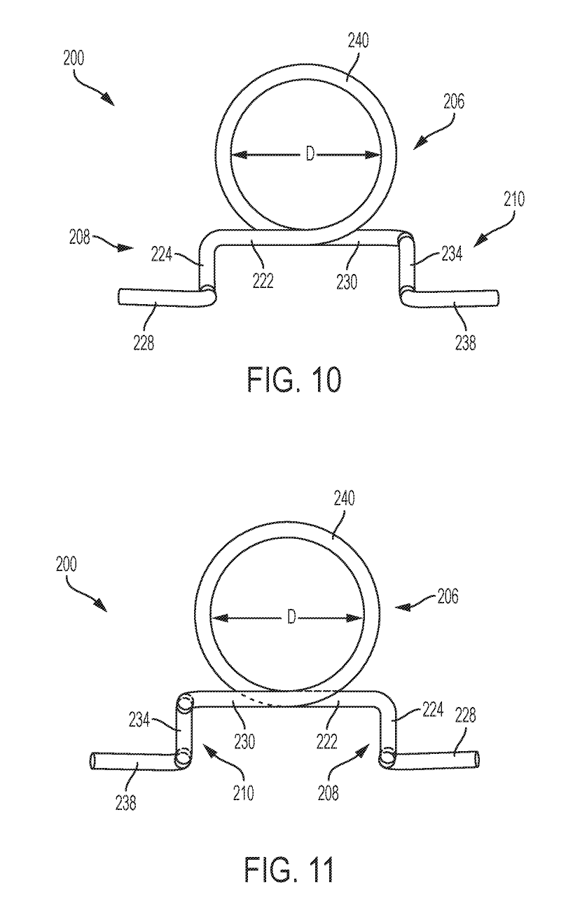

As shown in FIGS. 3-11, this section describes a dowel bar spring clip 200. Dowel bar spring clip 200 is an example of the clip generally described above.

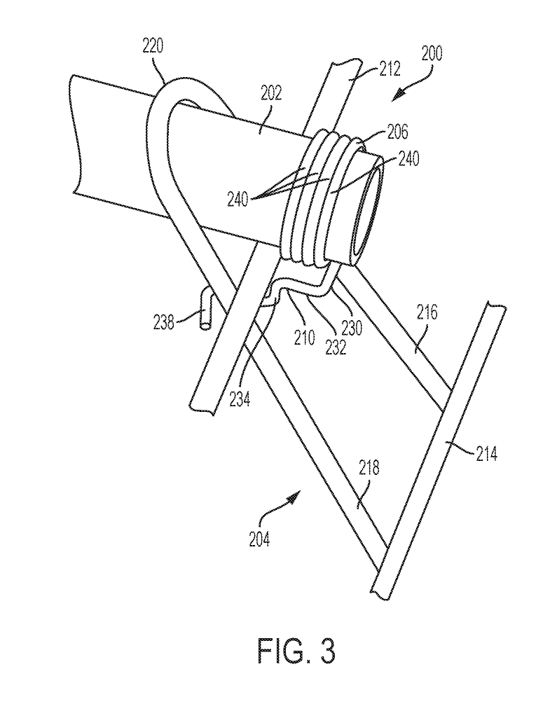

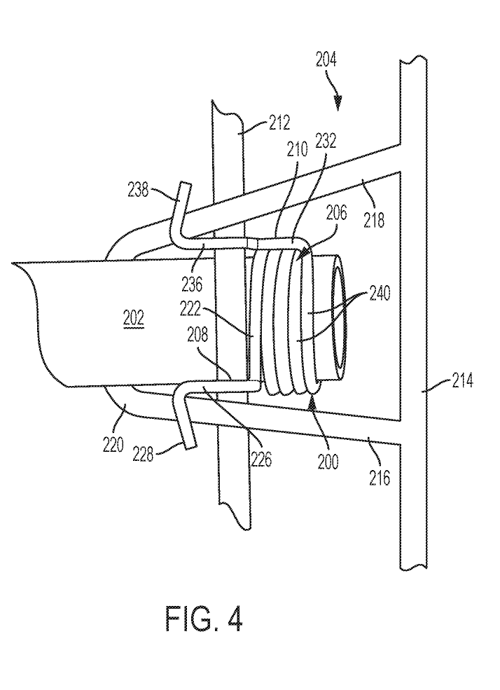

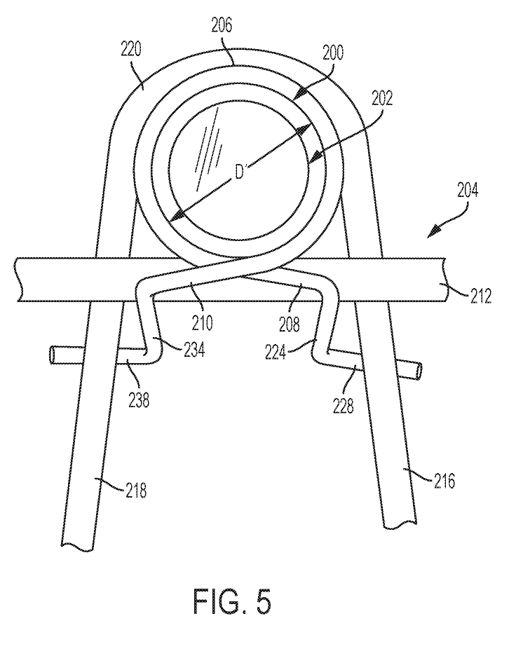

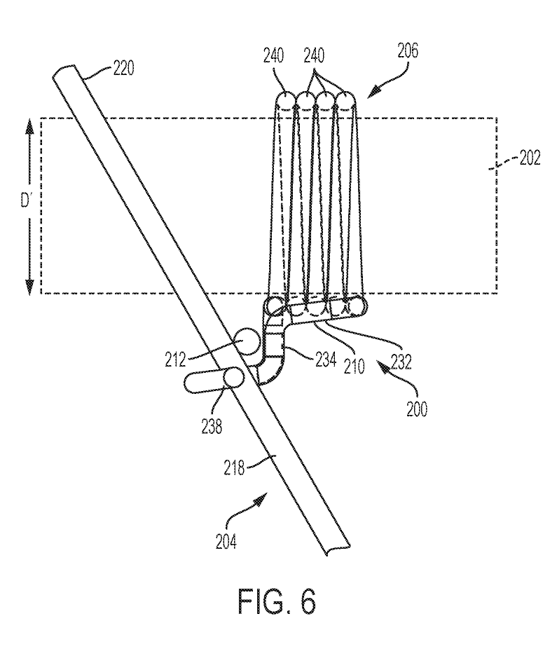

FIGS. 3-6 show various views of dowel bar spring clip 200 installed on an illustrative dowel bar 202 and a portion of an illustrative dowel bar basket 204. FIG. 3 is an isometric partial view of the bar-basket-clip assembly, FIG. 4 is a bottom view, and FIG. 5 is an end view taken from an outboard vantage point. FIG. 6 is a side view, showing the relationship between clip 200, dowel bar 202, and basket 204. Dowel bar spring clip 200 includes a torsion spring portion 206 and two basket engagement members 208 and 210, which comprise selectively-shaped extensions of the spring portion.

In this example, basket 204 includes an upper cross member 212, a lower cross member 214, and a pair of upright legs 216, 218 extending from lower cross member 214 across cross member 212 to form an upper hoop portion 220, through which the dowel bar protrudes.

Torsion spring portion 206 may include any suitable torsion spring having at least one coil forming a complete circumference. In this example, torsion spring portion 206 is a coiled wire having four coils. More or fewer coils may be suitable. Torsion spring portion 206 (and remaining portions of the clip) may comprise any suitable material or combination of materials. For example, the spring portion may comprise hard drawn spring steel wire, approximately one-eighth of an inch in diameter.

Torsion spring portion 206 defines a central axis and a resting diameter D, where D is approximately equal or slightly smaller than a diameter D′ of dowel bar 202. For example, D may be approximately 0.015 inches smaller than D′. Diameter D′ may be any suitable size, including about 1.5 inches, about 1.25 inches, and/or about 1.875 inches.

Diameter D may be reversibly increased or decreased by applying torque to the coils, e.g., via a squeezing force applied to the ends of the spring. For example squeezing or otherwise pushing inwardly on the ends of the spring will enlarge the effective size of diameter D. Releasing the torque on the spring will cause the spring to return to diameter D. If diameter D′ of dowel bar 202 is slightly larger than D, and torsion spring portion 206 is disposed around the dowel bar, then the diameter of the torsion spring will be limited to diameter D′. Accordingly, releasing the diameter-increasing torque previously applied to the torsion spring will apply a securing force on the dowel bar, because torsion spring portion 206 will continue to be biased toward original (smaller) diameter D.

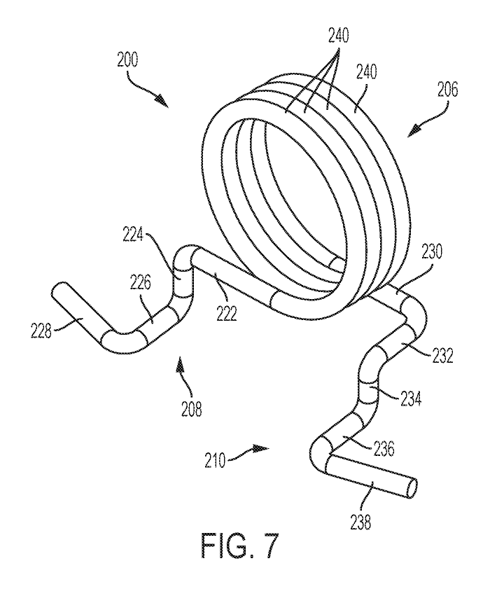

FIGS. 7-11 are various views of clip 200. As shown in FIGS. 3-11, first engagement member 208 comprises a first extension of the wire of torsion spring portion 206, extending from an inboard side of the spring. First engagement member 208 may include any suitable member extending from torsion spring portion 206 and configured to releasably engage dowel basket 204. For example, member 208 may form a hook configured to releasably engage a hookable portion of the dowel basket, such as upper cross-member 212 or one of upright leg members 216 and 218 of the basket.

Member 208 extends tangentially from the coil for a first or tangential segment 222, then turns downward and proceeds for a second or downward segment 224. Second segment 224 turns away from the coil and proceeds for a third or longitudinal segment 226 that is approximately parallel to the central axis of the torsion spring. Member 208 then turns in an outward direction, transverse to the central axis, forming a final (4th) or hook segment 228.

The various segments of member 208 may be oriented and angled in any suitable fashion configured to facilitate hooking onto basket 204. In this example, and as best shown in FIGS. 6-11, downward segment 224 may be oriented approximately vertically, i.e., orthogonally with respect to the ground when installed. Third segment 226 may be generally parallel to the ground, or may be angled slightly (e.g., downward) as the segment proceeds away from the spring. Hook segment 228 may extend generally outward, as mentioned above, and may also extend at an angle in an outboard direction. For example, segment 228 may form an acute angle with segment 226. For example, the hook segment may be oriented at an approximately 75-degree angle, with the distal end of the segment being closer to the torsion spring than the proximal end.

Similarly, second engagement member 210 comprises an extension of the other end of the wire of torsion spring portion 206, thereby extending from an outboard side of the spring. Member 210 extends tangentially from the coil for a first or tangential segment 230, then turns to generally parallel the central axis of the torsion spring in a second or wraparound segment 232, which is approximately as long as the axial dimension of the torsion spring portion. Remaining segments of member 210 are essentially a mirror image of corresponding segments of member 208. Accordingly, member 210 then turns downward and proceeds for a third or downward segment 234. Third segment 234 turns away from the coil and proceeds for a fourth or longitudinal segment 236 that is approximately parallel to the central axis. Member 210 then turns in an outward direction, transverse to the central axis, forming a final (5th) or hook segment 238. Hook segment 238 is oriented opposite to hook segment 228, as shown in FIGS. 3-11.

As with member 208, the various segments of member 210 may be oriented and angled in any suitable fashion configured to facilitate hooking onto basket 204. In this example, and as best shown in FIGS. 6-11, wraparound segment 232 may proceed generally horizontally in an inboard direction, or may have a slight downward angle. For example, segment 232 may extend at an approximately seven degree angle below horizontal. Downward segment 234 may nevertheless be oriented approximately vertically, i.e., orthogonally with respect to the ground when installed. Fourth segment 236 may be generally parallel to the ground, or may be angled slightly (e.g., downward) as the segment proceeds away from the spring. Hook segment 238 may extend generally outward, as mentioned above, and may also extend at an angle in an outboard direction (e.g., similar to hook segment 228). For example, segment 238 may form an acute angle with segment 236. For example, the hook segment may be oriented at an approximately 75-degree angle, with the distal end of the segment being closer to the torsion spring than the proximal end.

The shapes of members 208 and 210 are generally configured to allow torsion spring portion 206 to engage an end portion of dowel bar 202 while hook segments 228 and 238 wrap around or otherwise engage with legs or other structural members of basket assembly 204. Additionally, members 208 and 210 may be configured to allow manual application of torque to torsion spring portion 206, such as by squeezing the opposing members toward each other. Downward segments 224 and 234 may be suitable for facilitating such manipulation, as they present a convenient manual interface for a user's fingers (e.g., thumb and forefinger).

Portions of clip 200 may be configured to contact or engage with basket assembly 204. For example, hook segments 228 and 238 may hook around upright legs 216, 218 of the basket assembly. Suitable places on or portions of basket assembly 204 (where hook segments may engage the basket assembly) may be referred to as hookable portions.

In some examples, other portions of engagement members 208 and 210 may conform to or abut portions of the basket assembly, such as when downward and longitudinal segments wrap around a cross member of the basket. Downward segments 224 and 234 may abut cross member 212 when dowel bar 202 and/or clip 200 are properly positioned, thereby ensuring proper placement of the dowel bar and clip, preventing excessive axial repositioning of the dowel bar, and/or maintaining the positions of the hook segments. Accordingly, the portion of the engagement members comprising downward segments 224 and 234 may be referred to as an abutment portion.

When torsion spring portion 206 is engaged securely with dowel bar 202 and engagement members 208 and 210 are hooked onto basket 204, the corresponding end portion of dowel bar 202 is secured to the basket. Securing the dowel bar in this manner facilitates quick, no-tools-required fastening of the dowel bar to the basket, and also may function to properly and squarely orient the dowel bar with respect to the overall basket assembly. Furthermore, as clip 200 is relatively flexible, an opposite end of the dowel bar may be free to pivot slightly without disengaging the first end. This may facilitate securing the opposite end. For similar reasons, dowel bar 202 may be easily removed and/or repositioned with respect to basket 204, especially compared with situations where the bar is welded to the basket.

In summary, clip 200 may be described as a device for attaching dowel bar 202 to dowel basket 204. Clip 200 may include torsion spring portion 206, which is configured to fit securely around a complete circumference of dowel bar 202, and an engagement member (e.g., 208, 210) extending from the torsion spring, the engagement member having a distal end portion (e.g., 228, 238) configured to releasably engage the dowel basket.

The assembly of dowel basket 204, dowel bar 202, and clip 200 may be described as a load transfer assembly for road construction. The assembly may include dowel basket 204, dowel bar 202 coupled to the dowel basket, and spring clip 200, which includes torsion spring 206 having a plurality of coils 240 fitting securely around a complete circumference of an end portion of the dowel bar, the torsion spring having a pair of leg extensions (208, 210) removably hooked onto the dowel basket, such that the spring clip releasably secures the end portion of the dowel bar to the dowel basket.

Additional Spring Clip Examples

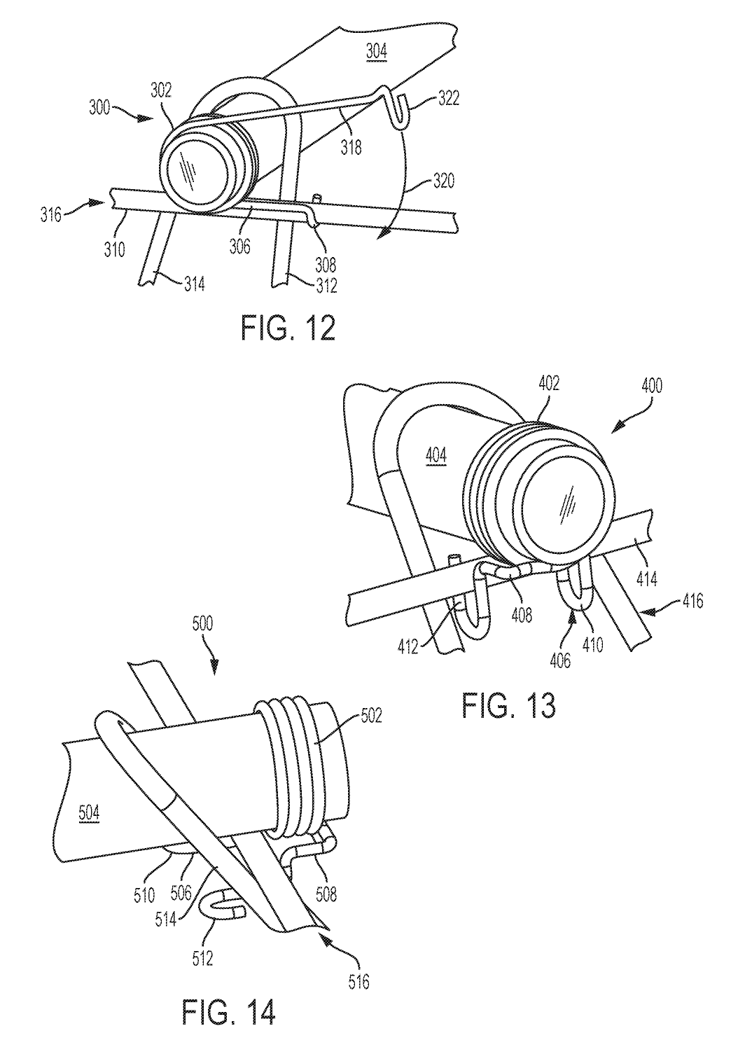

As shown in FIGS. 12-15, this section describes additional or alternative embodiments of dowel bar spring clips. These dowel bar spring clips are examples of the clip described generally in the Overview above, and are similar to clip 200. Accordingly, corresponding components may be understood to have similar functionality and description, unless described otherwise.

FIG. 12 depicts a spring clip 300 having a central torsion spring portion 302, configured to grip a dowel bar 304 substantially as described above regarding spring portion 206. In this embodiment, clip 300 has two straight engagement members, one substantially longer than the other. As depicted in FIG. 12, a first engagement member 306 is an extension of the torsion spring wire that proceeds tangentially from the bottom side of the spring, and terminates in a vertically-oriented hook portion 308 that hooks under a cross member 310 outside upright legs 312, 314 of a basket 316. A second engagement member 318 extends tangentially from the torsion spring, generally opposite first engagement member 306 (e.g., from the top side of the spring). Engagement member 318 extends for a longer distance than engagement member 306, allowing member 318 to be pivoted downward (as indicated by arrow 320) such that a terminal hook portion 322 can engage cross member 310. Hook portion 322 is shown in a disengaged position in FIG. 12.

FIG. 13 depicts a spring clip 400 having a torsion spring portion 402 configured to engage a dowel bar 404, and a pair of engagement members 406, 408 configured substantially similar to those of clip 200. However, members 406 and 408 terminate in U-shaped, vertically-oriented hook portions 410 and 412, respectively. Hook portions 410 and 412 are configured to engage a cross member 414 of a basket assembly 416, as contrasted with the substantially horizontal, straight hook portions of clip 200, which are configured to engage upright leg portions of the basket assembly.

FIG. 14 depicts a spring clip 500 having a torsion spring portion 502 configured to engage a dowel bar 504, and a pair of engagement members 506, 508 substantially identical to those of clip 200 with the exception of the terminal hook segments. With respect to clip 500, engagement members 506 and 508 terminate in U-shaped, horizontally-oriented hook portions 510 and 512, respectively. Hook portions 510 and 512 are configured to engage leg members 514 of a basket assembly 516 by hooking around the legs, as contrasted with the straight hook segments of clip 200, which hook inboard of (e.g., “behind”) the legs.

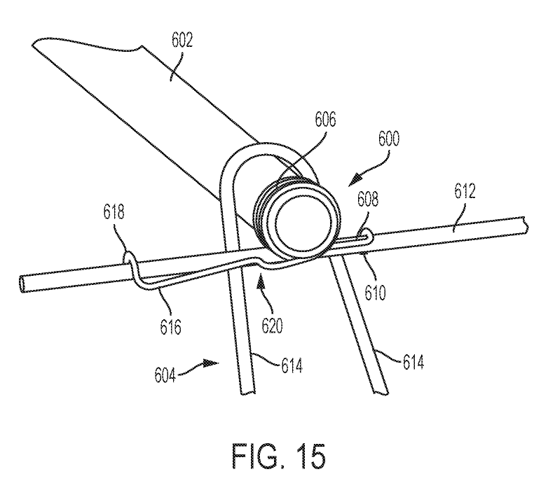

FIG. 15 is an isometric view of a dowel bar spring clip 600 engaged on a dowel bar 602 and a basket 604. Spring clip 600 includes a central torsion spring portion 606, configured to grip dowel bar 602 substantially as described above regarding spring portion 206. In this example, clip 600 has two engagement members extending generally tangentially from the bottom of the spring portion, one member being substantially longer than the other. As depicted in FIG. 15, a first engagement member 608 is an extension of the torsion spring wire that proceeds tangentially from the bottom of the spring, and terminates in a vertically-oriented, downward-opening hook portion 610 that hooks over a cross member 612 outside upright legs 614 of the basket assembly.

A second engagement member 616 extends tangentially from the bottom of the torsion spring, and terminates in a vertical, downward-opening hook portion 618 that hooks over cross member 612, similar to hook portion 610. Member 616 extends from a position generally opposite first engagement member 608. Engagement member 616 extends for a longer distance than engagement member 608, i.e., a length of the second engagement member is greater than a length of the first engagement member. This facilitates greater leverage when manually positioning member 616. This may be important, for example, when member 608 is first hooked onto cross member and member 616 must be pivoted upward to engage hook 618 with the cross member. Such pivoting may also serve to place additional holding force on the dowel member, as it places additional constricting torque on spring portion 606.

Similar to the abutment portion created in spring clip by downward segments 224 and 234, the substantially vertical portions of hooks 610 and 618 will abut the cross member of the basket when the hooks are engaged. This will oppose axial (i.e., inboard) movement of the dowel bar.

Because a proximal end of second member 616 originates at a position spaced from the proximal end of first member 608, second member 616 is also spaced from the cross member. Accordingly, an offset bend 620 may be present in member 616 to bring the distal end of member 616 closer to cross member 612.

Illustrative Method

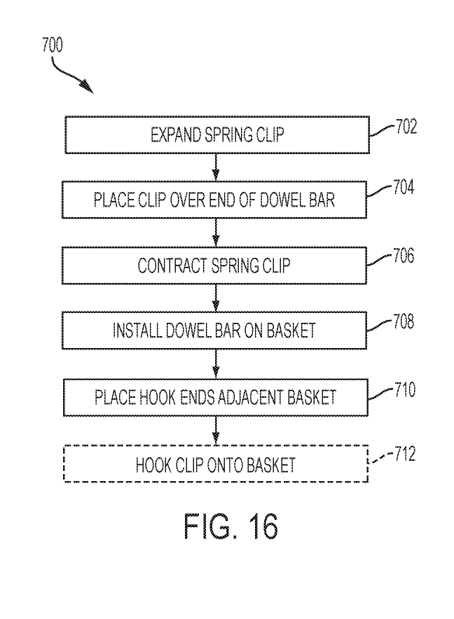

This section describes a method 700 for attaching a dowel bar to a basket assembly when constructing a highway or other road; see FIG. 16. Aspects of dowel bar spring clips described above may be utilized in the method steps described below. Where appropriate, reference may be made to previously described components and systems that may be used in carrying out each step. These references are for illustration, and are not intended to limit the possible ways of carrying out any particular step of the method.

The method described below may not recite the complete process or all steps of the method. Although various steps of the method are described below, the steps need not necessarily all be performed, and in some cases may be performed in a different order than the order discussed. Selected examples of optional performance orders and suitable sub-portions of the process are listed below the numbered steps.

Step 702 includes expanding a torsion spring portion (e.g., spring portions 206, 302, 402, 502, 606) of a spring clip. Any suitable force vector may be used to expand the torsion spring portion. For example, expanding the spring clip may be achieved by applying a squeezing force on opposing extension members of the clip, thereby increasing an effective diameter of the torsion spring. In general, a torsion spring portion of a clip may be torqued either by squeezing opposing extension members generally toward each other (e.g., with clip 200) or by pulling them generally away from each other (e.g., with clip 300), thereby increasing the effective diameter of the torsion spring.

Step 704 includes placing the torsion spring portion over an end of the dowel bar, such that the dowel bar and the torsion spring are coaxial and the torsion spring surrounds the outer circumference of the dowel bar.

Step 706 includes contracting the torsion spring portion (i.e., allowing the torsion spring portion to contract) to cause the spring clip to engage the dowel bar, by releasing the expansion-causing force on the extension members. Said another way, the torque placed on the torsion spring may be released, such as by releasing the extension members that were squeezed (or pulled away from each other) in a previous step.

Step 708 includes installing the dowel bar (e.g., dowel bar 202) on a dowel bar basket (e.g., basket 204). Step 702 may include inserting the dowel bar through one or more retaining structures of the basket. For example, the dowel bar may be inserted through a hoop portion (e.g., hoops 106, 130, 220) or other retaining mechanism of the basket assembly.

Step 710 includes placing hook ends (e.g., hook segments 228 and 238, 308 and 322, 410 and 412, etc.) of the extension members of the clip adjacent to hookable portions of the basket. For example the hook ends may be placed adjacent to a cross member or an upright support leg of the basket.

Method 700 may further include step 712, which includes attaching the spring clip to the basket by engaging the hook ends with the hookable portions of the basket. For example, using spring clip 600, shorter first engagement member 606 may be hooked over a cross member of the basket on one side of the dowel bar using hook 608. Then, with hook 608 remaining engaged, longer second engagement member 616 may be hooked over the cross member on the other side of the dowel bar using hook 618.

Method 700 may further include detaching the spring clip from the basket by disengaging the hook ends from the hookable portions of the basket. In some examples, method 700 may include disengaging the torsion spring from the dowel bar by, e.g., again squeezing the opposing extension members. In some examples, this may be performed to remove the dowel bar from the basket. The dowel bar may be reconnected to the basket using the same spring clip. In some examples, this may be performed to reposition the dowel bar relative to the basket.

In some examples, steps may be performed in a different order. For example, steps may be performed in the order 708-702-704-710-706-712. In other words, the dowel bar may be installed on the basket before any other steps, and the hook ends may be positioned relative to the basket before releasing the expansion-causing force on the torsion spring.

In some examples, only a portion of the steps may be performed. For example, a clip may be installed on the dowel bar, by performing steps 702, 704, and 706, at which point the process may be halted or paused. This may be done, for example, to pre-assemble multiple bar-clip combinations to be installed at a later time on a dowel basket.

### Additional Examples and Illustrative Combinations

This section describes additional aspects and features of dowel bar spring clips and related methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A device for attaching a dowel bar to a dowel basket may include a torsion spring portion configured to fit securely around a complete circumference of a dowel bar; and an engagement member extending from the torsion spring, the engagement member having a distal end portion configured to releasably engage the dowel basket.

A1. The device of paragraph A0, wherein the engagement member includes a first and a second extension of the torsion spring, each of the first and second extensions terminating in a respective hook portion.

A2. The device of any of paragraphs A0 through A1, wherein the torsion spring portion defines a rest diameter smaller than a diameter of the dowel bar.

A3. The device of any of paragraphs A0 through A2, wherein the engagement member further includes an abutment portion configured to arrest axial motion of the secured dowel bar when the abutment portion contacts the basket.

A4. The device of any of paragraphs A0 through A3, wherein the distal end portion of the engagement member comprises a hook.

A5. The device of paragraph A4, wherein the hook is configured to engage an upright leg member of the basket.

A6. The device of paragraph A4, wherein the hook is configured to engage a cross member of the basket.

B0. A load transfer assembly for road construction may include: a dowel basket; a dowel bar coupled to the dowel basket; and a spring clip including a torsion spring having a plurality of coils fitting securely around a complete circumference of an end portion of the dowel bar, the torsion spring having a pair of leg extensions removably hooked onto the dowel basket, such that the spring clip releasably secures the end portion of the dowel bar to the dowel basket.

B1. The assembly of paragraph B0, wherein the pair of leg extensions includes a first leg extension hooked onto a first component of the dowel basket and a second leg extension hooked onto a second component of the dowel basket, the first and second components of the dowel basket being disposed on laterally opposite sides of the dowel bar.

B2. The assembly of any of paragraphs B0 through B1, wherein at least one leg extension of the pair of leg extensions includes an abutment portion configured to arrest axial motion of the secured dowel bar when the abutment portion contacts the basket.

B3. The assembly of any paragraph B2, wherein the abutment portion comprises a substantially vertical segment of the at least one leg extension.

C0. A method for securing a dowel bar to a dowel bar basket may include: expanding a torsion spring portion of a spring clip by applying a squeezing force on opposing extension members of the clip, thereby increasing an effective diameter of the torsion spring; placing the torsion spring portion over an end of a dowel bar, such that the dowel bar and the torsion spring are coaxial and the torsion spring surrounds the outer circumference of the dowel bar; contracting the torsion spring to cause the spring clip to engage the dowel bar by releasing the squeezing force on the extension members; installing the dowel bar on a dowel bar basket; and placing hook ends of the extension members of the clip adjacent to hookable portions of the dowel bar basket.

C1. The method of paragraph C0, further including attaching the spring clip to the basket by engaging the hook ends with the hookable portions of the basket.

C2. The method of paragraph C1, further including detaching the spring clip from the basket by disengaging the hook ends from the hookable portions of the basket.

C3. The method of any of paragraphs C0 through C2, further including disengaging the torsion spring from the dowel bar by again squeezing the opposing extension members.

C4. The method of paragraph C3, further including removing the dowel bar from the basket.

C5. The method of paragraph C4, further including reconnecting the dowel bar to the basket using the same spring clip.

C6. The method of paragraph C3, further including repositioning the dowel bar relative to the basket.

C7. The method of any of paragraphs C0 through C6, wherein installing the dowel bar includes inserting the dowel bar through a retaining structure of the basket.

C8. The method of paragraph C7, wherein the retaining structure is a hoop portion of the basket.

Advantages, Features, Benefits

The different embodiments of the dowel bar spring clips described herein provide several advantages over known solutions for attaching dowel bars to basket assemblies. For example, the illustrative embodiments of dowel bar spring clips described herein allow elimination of welding. Welding can create a surface defect in a coated or clad dowel bar, where corrosion can occur. Welding of dissimilar metals (e.g., stainless steel dowel surface to carbon steel basket) can be problematic. Welding of dowel bars containing epoxy or zinc also creates toxic fumes that must be controlled. Welding is not an option when using fiberglass or fiberglass-clad dowels. Furthermore, if a weld breaks, repairs are cumbersome. Accordingly, elimination of welding is advantageous.

Additionally, and among other benefits, illustrative embodiments of the dowel bar spring clips described herein allow a dowel to be installed securely in the field without any special tools. For similar reasons, any given dowel can also be easily removed or positionally adjusted after installation, unlike with welded dowels.

In another example of a benefit, illustrative embodiments of the dowel bar spring clips described herein may be configured to properly orient the dowel bars relative to the supporting basket assembly. For example, a spring clip may be configured such that a dowel bar held in the spring portion of the clip is forced to be perpendicular to a basket assembly component (e.g., siderail/cross-member) that is held by the engagement portion of the clip.

No known system or device can perform these functions. Thus, the illustrative embodiments described herein are particularly useful for field installation and assembly of dowel bars in the highway construction process. However, not all embodiments described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A device for attaching a dowel bar to a dowel basket, the device comprising:
a torsion spring portion configured to fit securely around a complete circumference of a dowel bar; and
an engagement member extending from the torsion spring, the engagement member having a distal end portion configured to releasably engage the dowel basket.

2. The device of claim 1, wherein the engagement member includes a first and a second extension of the torsion spring, each of the first and second extensions terminating in a respective hook portion.

3. The device of claim 1, wherein the torsion spring portion defines a rest diameter smaller than a diameter of the dowel bar.

4. The device of claim 1, wherein the engagement member further includes an abutment portion configured to arrest axial motion of the secured dowel bar when the abutment portion contacts the basket.

5. The device of claim 1, wherein the distal end portion of the engagement member comprises a hook.

6. The device of claim 5, wherein the hook is configured to engage an upright leg member of the basket.

7. The device of claim 5, wherein the hook is configured to engage a cross member of the basket.

8. A load transfer assembly for road construction, the assembly comprising:
a dowel basket;
a dowel bar coupled to the dowel basket; and
a spring clip including a torsion spring having a plurality of coils fitting securely around a complete circumference of an end portion of the dowel bar, the torsion spring having a pair of leg extensions removably hooked onto the dowel basket, such that the spring clip releasably secures the end portion of the dowel bar to the dowel basket.

9. The assembly of claim 8, wherein the pair of leg extensions are hooked onto the dowel basket on laterally opposite sides of the dowel bar.

10. The assembly of claim 8, wherein at least one leg extension of the pair of leg extensions includes an abutment portion configured to arrest axial motion of the secured dowel bar when the abutment portion contacts the basket.

11. The assembly of claim 10, wherein the abutment portion comprises a substantially vertical segment of the at least one leg extension.

12. A method for securing a dowel bar to a dowel bar basket, the method comprising:
expanding a torsion spring portion of a spring clip by applying a squeezing force on opposing extension members of the clip, thereby increasing an effective diameter of the torsion spring;
placing the torsion spring portion over an end of a dowel bar, such that the dowel bar and the torsion spring are coaxial and the torsion spring surrounds the outer circumference of the dowel bar;
contracting the torsion spring to cause the spring clip to engage the dowel bar by releasing the squeezing force on the extension members;
installing the dowel bar on a dowel bar basket; and
placing hook ends of the extension members of the clip adjacent to hookable portions of the dowel bar basket.

13. The method of claim 12, further including attaching the spring clip to the basket by engaging the hook ends with the hookable portions of the basket.

14. The method of claim 13, further including detaching the spring clip from the basket by disengaging the hook ends from the hookable portions of the basket.

15. The method of claim 12, further including disengaging the torsion spring from the dowel bar by again squeezing the opposing extension members.

16. The method of claim 15, further including removing the dowel bar from the basket.

17. The method of claim 16, further including reconnecting the dowel bar to the basket using the same spring clip.

18. The method of claim 15, further including repositioning the dowel bar relative to the basket.

19. The method of claim 12, wherein installing the dowel bar includes inserting the dowel bar through a retaining structure of the basket.

20. The method of claim 19, wherein the retaining structure is a hoop portion of the basket.
